(19) United States
(12) Patent Application Publication
(10) Pub. No.: US 2017/0195710 A1
(43) Pub. Date: Jul. 6, 2017

(54) METHOD AND ELECTRONIC DEVICE FOR PREVIEW PLAY

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Xiaofei ZAN, Beijing (CN)

(21) Appl. No.: 15/243,382

(22) Filed: Aug. 22, 2016

Related U.S. Application Data
(63) Continuation of application No. PCT/CN2016/089281, filed on Jul. 7, 2016.

(30) Foreign Application Priority Data
Dec. 31, 2015 (CN) 201511023878.8

(51) Int. Cl. H04N 21/431; H04N 21/458; H04N 21/472

(52) U.S. Cl. CPC H04N 21/4316; H04N 21/47202; H04N 21/458

(57) ABSTRACT

The present disclosure relates to a method and an electronic device for preview play. The method includes: determining a flag of a preview window when the preview window receives a play instruction; obtaining a pre-built corresponding relation of the flag of the preview window and a video resource; determining the video resource corresponding to the flag of the preview window according to the corresponding relation; and playing the video resource in the preview window. If a user wants to know whether he/she is interested in the video resource corresponding to the preview window, he or she may input a play instruction into the preview window. When the preview window receives the play instruction inputted by the user, it needs to determine a corresponding video resource via the flag of the preview window so that the video resource is played in the preview window.

### CROSS REFERENCE TO RELATED APPLICATION

The present application is the continuous application of the PCT application PCT/CN2016/089281, filed on Jul. 7, 2016. The present disclosure claims priority of the Chinese patent application No. 2015110238788, titled “METHOD AND DEVICE FOR PREVIEW PLAY”, filed with the State Intellectual Property Office of China on Dec. 31, 2015, the entire contents of which are incorporated herein by reference.

### TECHNICAL FIELD

The present disclosure relates to the field of communication technology, and in particular, to a method and an electronic device for preview play.

### BACKGROUND

At present, software for playing a video on a terminal may display a preview window of the video through which users may know the content of the video.

In the preview window, only an image and proper texts are displayed to indicate corresponding information of the video. When watching the image and texts in the preview window, users need to judge whether they like the video through the image and texts in the preview window and decide whether to play.

However, because the image and texts in the preview window cannot effectively convey the substantial content of the video, users cannot know whether the video has a highlight that interests them by the image and texts in the preview window. Moreover, in some cases, the image and texts in the preview window easily mislead users to an incorrect judgment on the video. Therefore, the above relevant technology fails to provide users with a good preview experience.

### SUMMARY

The present disclosure provides a method and an electronic device for preview play so that a preview window displays a video resource directly, thereby providing a better preview experience.

According to a first aspect of embodiments of the present disclosure, it provides a method for preview play, including:

determining a flag of a preview window when the preview window receives a play instruction;

obtaining a pre-built corresponding relation of the flag of the preview window and a video resource;

determining the video resource corresponding to the flag of the preview window according to the corresponding relation; and

playing the video resource in the preview window.

The embodiments of the present disclosure further provide a non-transitory computer-readable storage medium storing executable instructions that, when executed by an electronic device with a touch-sensitive display, cause the electronic device to execute any one of the method for preview play aforementioned.

The embodiments of the present disclosure further provide an electronic device, which includes: at least one processor; and a memory communicably connected with the at least one processor for storing instructions executable by the at least one processor, wherein execution of the instructions by the at least one processor causes the at least one processor to execute any one of the method for preview play aforementioned.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for preview play according to embodiments of the present disclosure.

FIG. 2 is a flow chart of another method for preview play according to embodiments of the present disclosure.

FIG. 3 is a flow chart of yet another method for preview play according to embodiments of the present disclosure.

FIG. 4 is a flow chart of yet another method for preview play according to embodiments of the present disclosure.

FIG. 5 is a flow chart of yet another method preview play according to embodiments of the present disclosure.

FIG. 6 is a diagram of the hardware configuration of the device for the method for preview play according to embodiments of the present disclosure.

### DETAILED DESCRIPTION

The technical solutions in the embodiments of the present disclosure will be described clearly and fully below in conjunction with the drawings in the embodiments of the present disclosure. Apparently, the embodiments described are only a part of the embodiments of the present disclosure, rather than being the whole embodiments. All the other embodiments obtained by one of ordinary skills in the art based on the embodiments of the present disclosure without creative effort will fall into the scope of the present disclosure.

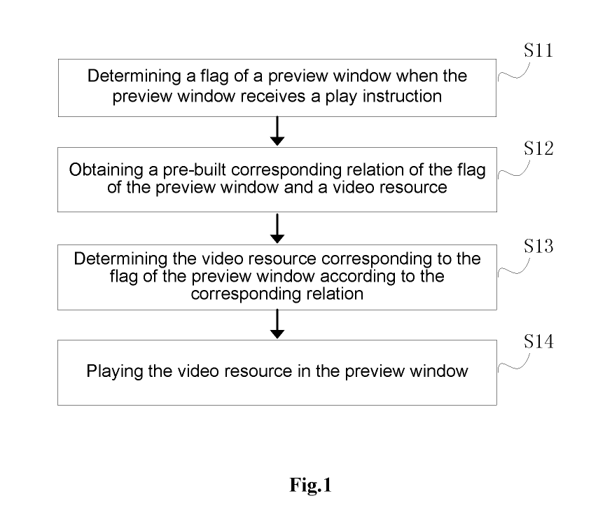

FIG. 1 is a flow chart of a method for preview play according to embodiments of the present disclosure. The method for preview play as shown in FIG. 1 may be applied to a terminal. The method for preview play provided by the present disclosure may directly display video resource in the preview window so as to help users to quickly know whether the video resource interests them, thereby providing a better preview experience. The method includes the following steps.

In step S11: determining a flag of a preview window when the preview window receives a play instruction.

The method provided by the present disclosure is applied to a terminal in which video play software may be installed. The terminal may be a smart TV, a smart phone, a tablet computer, a desktop computer or a laptop and other devices.

Where the terminal is a smart TV, users may use a remote control to choose the preview window of the video play software of the smart TV and input a play instruction of the preview window into the smart TV. When the preview window of the video play software of the smart TV receives a play instruction, the smart TV will determine a flag of the preview window so that subsequent steps may determine the video resource according to the flag.

Where the terminal is a computer, users may use a mouse to choose the preview window of the video play software of the computer and input a play instruction of the preview window into the smart TV. When the preview window of the video play software of the computer receives a play instruction, the computer will determine a flag of the preview window so that subsequent steps may determine the video resource according to the flag.

Where the terminal is a smart phone, users may choose the preview window of the video play software of the smart phone and input a play instruction of the preview window into the smart phone. When the preview window of the video play software of the smart phone receives a play instruction, the computer will determine a flag of the preview window so that subsequent steps may determine the video resource according to the flag.

The flag of a preview window may be formed of characters, figures, English letters, Chinese characters or symbols. For example, the flag of a preview window may be in form of S1, 12345, or S−1.

In step S12: obtaining a pre-built corresponding relation of the flag of the preview window and a video resource.

There might exist multiple preview windows in the video play software of a terminal, therefore it is required to pre-build the corresponding relation of the flag of each preview window and video resources so that each preview window corresponds to one video resource.

For instance, supposing that there exist five preview windows in the video play software of the terminal: a first preview window, a second preview window, a third preview window, a fourth preview window and a fifth preview window, the pre-built corresponding relations of flags of preview windows and video resources are: flag S1 of the first preview window corresponds to video resource A; flag S2 of the second preview window corresponds to video resource B; flag S3 of the third preview window corresponds to video resource C; flag S4 of the fourth preview window corresponds to video resource D; and flag S5 of the fifth preview window corresponds to video resource E.

In step S13: determining the video resource corresponding to the flag of the preview window according to the corresponding relation.

After obtaining a pre-built corresponding relation of the flag of the preview window and a video resource, the terminal may determine the video resource corresponding to the flag of the preview window according to the corresponding relation.

For instance, supposing that there exist five preview windows in the video play software of the terminal: a first preview window, a second preview window, a third preview window, a fourth preview window and a fifth preview window, the pre-built corresponding relations of flags of preview windows and video resources are: flag S1 of the first preview window corresponds to video resource A; flag S2 of the second preview window corresponds to video resource B; flag S3 of the third preview window corresponds to video resource C; flag S4 of the fourth preview window corresponds to video resource D; and flag S5 of the fifth preview window corresponds to video resource E. Supposing that the third preview window in the video play software of the terminal receives a play instruction, the terminal will determine the flag S3 of the third preview window; then the terminal will obtain a pre-built corresponding relation of the flag of the preview window and a video resource. At this moment, the terminal will determine the video resource C corresponding to the flag S3 of the preview window according to the corresponding relation.

In step S14: playing the video resource in the preview window.

After determining the video resource corresponding to the flag of the preview window according to the corresponding relation, the terminal will play the video resource in the preview window so that users may see the video resource in the preview window, and users may quickly know whether the video resource interests them according to the video resource played in the preview window.

In the embodiment as shown in FIG. 1, if a user wants to know whether he/she is interested in the video resource corresponding to the preview window, he or she may input a play instruction into the preview window. When the preview window receives the play instruction inputted by the user, it needs to determine a corresponding video resource via the flag of the preview window so that the video resource is played in the preview window. In this way, the user may decide whether to watch the video resource by the video resource played in preview the window. Therefore, solutions provided by the disclosure may directly display the video resource in the preview window to help users to quickly know whether the video resource interests them, thereby providing a better preview experience.

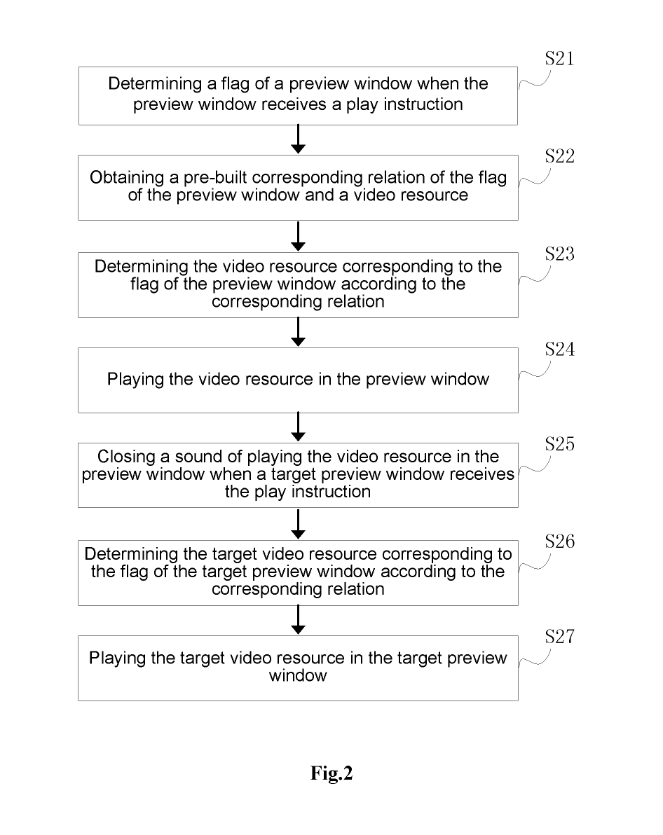

FIG. 2 is a flow chart of another method for preview play according to embodiments of the present disclosure. FIG. 2 is an optional embodiment based on FIG. 1. In the embodiment as shown in FIG. 2, the same part as the embodiment shown in FIG. 1 may be referred to introductions and illustrations in the embodiment of FIG. 1. The method of FIG. 2 includes the following steps.

In step S21: determining a flag of a preview window when the preview window receives a play instruction.

In step S22: obtaining a pre-built corresponding relation of the flag of the preview window and a video resource.

In step S23: determining the video resource corresponding to the flag of the preview window according to the corresponding relation.

In step S24: playing the video resource in the preview window.

In step S25: closing a sound of playing the video resource in the preview window when a target preview window receives the play instruction.

After playing the video resource in a preview window of the video play software of the terminal, the terminal needs to judge whether other preview windows of the video play software receive the play instruction. If judging that the target preview window of the video play software receives the play instruction, the terminal will close a sound of playing the video resource in the preview window and meanwhile ensure that the preview window only displays pictures of the video resource. Therefore, solutions provided by the present disclosure may prevent the problem of noisy sound generated by simultaneous playing video resources in multiple preview windows.

In step S26: determining the target video resource corresponding to the flag of the target preview window according to the corresponding relation.

After closing the sound of playing the video resource in the preview window, the terminal may determine the target video resource corresponding to the flag of the target preview window according to the pre-obtained corresponding relation.

In step S27: playing the target video resource in the target preview window.

After determining the target video resource corresponding to the flag of the target preview window according to the corresponding relation, the terminal may play the target video resource in the target preview window. As a result, users may watch the video resource played in the preview window and the target video resource played in the target preview window simultaneously; and the terminal only inputs the sound of the target video resource played in the target preview window.

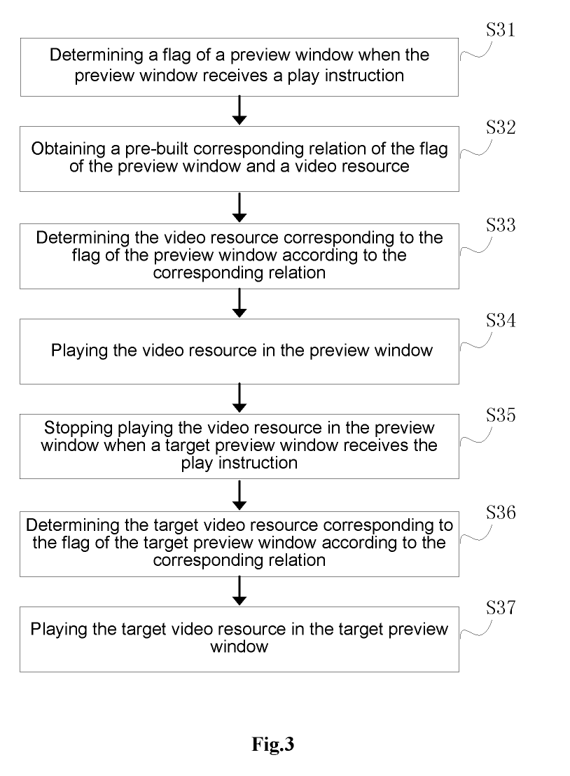

FIG. 3 is a flow chart of yet another method for preview play according to embodiments of the present disclosure. FIG. 3 is an optional embodiment based on FIG. 1. In the embodiment as shown in FIG. 3, the same part as the embodiment shown in FIG. 1 may be referred to introductions and illustrations in the embodiment of FIG. 1. The method of FIG. 3 includes the following steps.

In step S31: determining a flag of a preview window when the preview window receives a play instruction.

In step S32: obtaining a pre-built corresponding relation of the flag of the preview window and a video resource.

In step S33: determining the video resource corresponding to the flag of the preview window according to the corresponding relation.

In step S34: playing the video resource in the preview window.

In step S35: stopping playing the video resource in the preview window when a target preview window receives the play instruction.

After playing the video resource in a preview window of the video play software of the terminal, the terminal needs to judge whether other preview windows of the video play software receive the play instruction. If judging that the target preview window of the video play software receives the play instruction, the terminal will stop playing the video resource in the preview window, to ensure that the terminal can only play the video resource in one preview window at one time.

In step S36: determining the target video resource corresponding to the flag of the target preview window according to the corresponding relation.

After closing a sound of playing the video resource in the preview window, the terminal may determine the target video resource corresponding to the flag of the target preview window according to the pre-obtained corresponding relation.

In step S37: playing the target video resource in the target preview window.

After determining the target video resource corresponding to the flag of the target preview window according to the corresponding relation, the terminal may play the target video resource in the target preview window. At this time, video resources will not continue to be played in the preview window of the terminal. Thus, the problem of high system resource occupation rate brought by simultaneously playing video resources in multiple preview windows can be prevented.

For instance, supposing that there exist three preview windows in the video play software of the terminal: a first preview window, a second preview window and a third preview window, the pre-built corresponding relations of flags of preview windows and video resources are: flag S1 of the first preview window corresponds to video resource A; flag S2 of the second preview window corresponds to video resource B; and flag S3 of the third preview window corresponds to video resource C. Supposing that the third preview window in the video play software of the terminal receives a play instruction input by the user, the terminal will determine the flag S3 of the third preview window. Then the terminal will obtain a pre-built corresponding relation of the flag of the preview window and the video resource, determine the video resource C corresponding to the flag S3 of the preview window according to the corresponding relation, and finally play the video resource C in the third preview window. Supposing that the first preview window in the video play software of the terminal further receives a play instruction inputted by the user, the terminal will firstly stop playing the video resource C in the third preview window. Then, the terminal will determine the flag S1 of the first preview window and the video resource A corresponding to the flag S1 of the first preview window according to the corresponding relation, and finally play the video resource C in the third preview window.

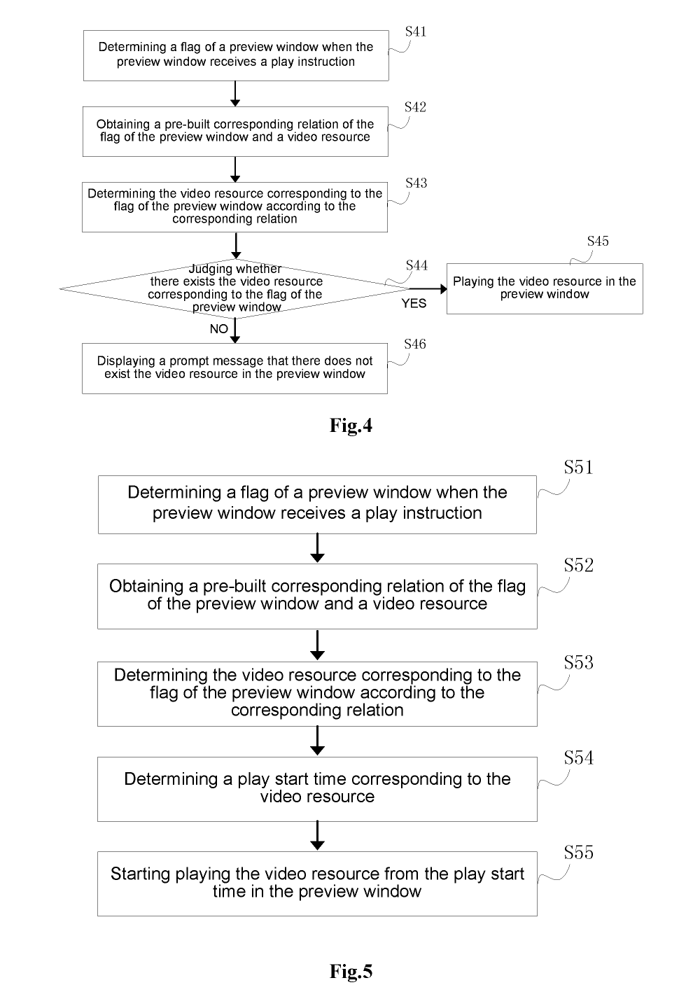

FIG. 4 is a flow chart of yet another method for preview play according to embodiments of the present disclosure. FIG. 4 is an optional embodiment based on FIG. 1. In the embodiment as shown in FIG. 4, the same part as the embodiment shown in FIG. 1 may be referred to introductions and illustrations in the embodiment of FIG. 1. The method of FIG. 4 includes the following steps.

In step S41: determining a flag of a preview window when the preview window receives a play instruction.

In step S42: obtaining a pre-built corresponding relation of the flag of the preview window and a video resource.

In step S43: determining the video resource corresponding to the flag of the preview window according to the corresponding relation.

In step S44: judging whether there exists the video resource corresponding to the flag of the preview window. When there exists the video resource corresponding to the flag of the preview window, triggering S45; when there does not exist the video resource corresponding to the flag of the preview window, triggering S46.

After determining the target video resource corresponding to the flag of the target preview window according to the corresponding relation, the terminal needs to judge whether there exists the video resource corresponding to the flag of the preview window. When the terminal judges there exists the video resource corresponding to the flag of the preview window, it means that the terminal may play the video resource in the preview window, so step S45 is triggered. When the terminal judges there does not the video resource corresponding to the flag of the preview window, it means that the terminal fails to play the video resource in the preview window, then the terminal will display a prompt message that there does not exist the video resource in the preview window, so that users can know that the preview window cannot play video resources.

In step S45: playing the video resource in the preview window.

In step S46: displaying a prompt message that there does not exist the video resource in the preview window.

FIG. 5 is a flow chart of yet another method for preview play according to embodiments of the present disclosure. FIG. 5 is an optional embodiment based on FIG. 1. In the embodiment as shown in FIG. 5, the same part as the embodiment shown in FIG. 1 may be referred to introductions and illustrations in the embodiment of FIG. 1. The method of FIG. 5 includes the following steps.

In step S51: determining a flag of a preview window when the preview window receives a play instruction.

In step S52: obtaining a pre-built corresponding relation of the flag of the preview window and a video resource.

In step S53: determining the video resource corresponding to the flag of the preview window according to the corresponding relation.

In step S54: determining a play start time corresponding to the video resource.

In order to make users see highlights of video resource in a preview window directly, a play start time of the highlights of the video resource in the preview window may be pre-determined. For instance, supposing that the time duration of a video resource is 50 minutes and highlights of the video resource is from 10 minutes to 20 minutes, the play start time corresponding to the video resource may be set for 10 minutes.

After determining the video resource corresponding to the flag of the preview window according to the corresponding relation, the terminal will determine a preset play start time corresponding to the video resource.

In step S55: starting playing the video resource from the play start time in the preview window.

After determining a play start time corresponding to the video resource, the terminal will start playing the video resource from the play start time in the preview window so that users can see the highlights of the video resource directly, thereby providing a better preview experience for users.

For instance, supposing that the time duration of video resource C is 40 minutes, and highlights of the video resource C is from 20 minutes to 30 minutes, the play start time corresponding to the video resource C may be preset at 20 minutes. For instance, supposing that there exist three preview windows in the video play software of the terminal: a first preview window, a second preview window and a third preview window, the pre-built corresponding relations of flags of preview windows and video resources are: flag S1 of the first preview window corresponds to video resource A; flag S2 of the second preview window corresponds to video resource B; and flag S3 of the third preview window corresponds to video resource C. Supposing that the third preview window in the video play software of the terminal receives a play instruction inputted by the user, the terminal will determine the flag S3 of the third preview window. Then the terminal will obtain a pre-built corresponding relation of the flag of the preview window and the video resource, and determine the video resource C corresponding to the flag S3 of the preview window according to the corresponding relation. At this time, the terminal needs to determine that the preset play start time corresponding to the video resource C is at 20 minutes. Finally, the terminal will start playing the video resource C from the play start time at 20 minute in the preview window so that users can see the highlights of the video resource directly, thereby providing a better preview experience for users.

The embodiment of the present disclosure provides a device for preview play. The device includes a first determining module 11, a first obtaining module 12, a second obtaining module 13 and a first playing module 14.

The first determining module 11 is configured to determine a flag of a preview window when the preview window receives a play instruction.

The first obtaining module 12 is configured to obtain a pre-built corresponding relation of the flag of the preview window and a video resource.

The second determining module 13 is configured to determine the video resource corresponding to the flag of the preview window according to the corresponding relation.

The first playing module 14 is configured to play the video resource in the preview window.

The embodiment of the present disclosure further provides another device for preview play. The device includes a first determining module 21, a first obtaining module 22, a second determining module 23, a first playing module 24, a closing module 25, a third determining module 26 and a second playing module 27.

The first determining module 21 is configured to determine a flag of a preview window when the preview window receives a play instruction.

The first obtaining module 22 is configured to obtain a pre-built corresponding relation of the flag of the preview window and a video resource.

The second determining module 23 is configured to determine the video resource corresponding to the flag of the preview window according to the corresponding relation.

The first playing module 24 is configured to play the video resource in the preview window.

The closing module 25 is configured to close a sound of playing the video resource in the preview window when a target preview window receives the play instruction.

The third determining module 26 is configured to determine the target video resource corresponding to the flag of the target preview window according to the corresponding relation.

The second playing module 27 is configured to play the target video resource in the target preview window.

The embodiment of the present disclosure further provides yet another device for preview play. The device includes a first determining module 31, a first obtaining module 32, a second determining module 33, a first playing module 34, a stop-playing module 35, a fourth determining module 36 and a third determining module 37.

The first determining module 31 is configured to determine a flag of a preview window when the preview window receives a play instruction.

The first obtaining module 32 is configured to obtain a pre-built corresponding relation of the flag of the preview window and a video resource.

The second determining module 33 is configured to determine the video resource corresponding to the flag of the preview window according to the corresponding relation.

The first playing module 34 is configured to play the video resource in the preview window.

The stop-playing module 35 is configured to stop playing the video resource in the preview window when a target preview window receives the play instruction.

The fourth determining module 36 is configured to determine the target video resource corresponding to the flag of the target preview window according to the corresponding relation.

The third playing module 37 is configured to play the target video resource in the target preview window.

The embodiment of the present disclosure further provides yet another device for preview play. The device includes a first determining module 41, a first obtaining module 42, a second determining module 43, a judging module 44, a triggering module 45, a first playing module 46 and a displaying module 47.

The first determining module 41 is configured to determine a flag of a preview window when the preview window receives a play instruction.

The first obtaining module 42 is configured to obtain a pre-built corresponding relation of the flag of the preview window and a video resource.

The second determining module 43 is configured to determine the video resource corresponding to the flag of the preview window according to the corresponding relation.

The judging module 44 is configured to judge whether there exists the video resource corresponding to the flag of the preview window.

The triggering module 45 is configured to trigger the first playing module when there exists the video resource corresponding to the flag of the preview window.

The first playing module 46 is configured to play the video resource in the preview window.

The displaying module 47 is configured to display a prompt message that there does not exist the video resource in the preview window when there does not exist the video resource corresponding to the flag of the preview window.

The embodiment of the present disclosure further provides yet another device for preview play. The device includes a first determining module 51, a first obtaining module 52, a second determining module 53, and a first playing module 54, and the first playing module 54 includes a determining submodule 541 and a playing submodule 542.

The first determining module 51 is configured to determine a flag of a preview window when the preview window receives a play instruction.

The first obtaining module 52 is configured to obtain a pre-built corresponding relation of the flag of the preview window and a video resource.

The second determining module 53 is configured to determine the video resource corresponding to the flag of the preview window according to the corresponding relation.

The first playing module 54 is configured to play the video resource in the preview window.

The determining submodule 541 is configured to determine a play start time corresponding to the video resource.

The playing submodule 542 is configured to start playing the video resource from the play start time in the preview window.

With respect to the devices in above embodiments, the specific modes for performing operation of each module have been described in details in the embodiments relevant to the method, and will not be illustrated here again in detail.

The embodiments of the present disclosure further provide a non-transitory computer-readable storage medium storing executable instructions that, when executed by an electronic device with a touch-sensitive display, cause the electronic device to execute any one of the method for preview play aforementioned.

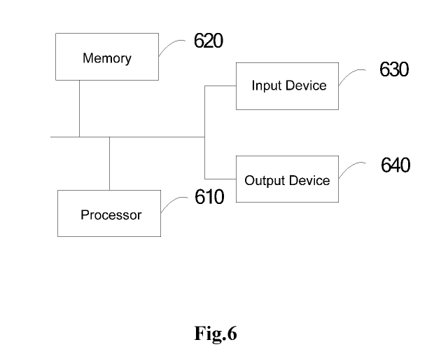

FIG. 6 is a diagram of the hardware configuration of the electronic device for executing the method for preview play provided by embodiments of the present disclosure. Referring to FIG. 6, the device includes: one or more processors 610 and a memory 620. In FIG. 6, only one processor 610 is shown as an example.

The device for executing the method for preview play may further include: an input device 630 and an output device 640.

The processor 610, the memory 620, the input device 630 and the output device 640 may be connected by bus or other means. FIG. 6 shows the devices are connected by bus as an example.

The memory 620 is a nonvolatile computer-readable storage media, which may be used to store nonvolatile software program, nonvolatile computer-executable program and module, such as the program instruction/module corresponding to the method for preview play of the embodiments of the present disclosure. The processor 610 may perform various functions and applications of the server and process data by running the nonvolatile software program, instructions and module stored in the memory 620, so as to realize the method for preview play of the examples aforementioned.

The memory 620 may include a program storage area and a data storage area, wherein the program storage area may store an operation system and an application program for achieving at least one function; the data storage area may store data established according to the use of the device for preview play. In addition, the memory 620 may include a high-speed random access memory, and may further include a non-volatile memory, such as at least one of magnetic disk memory, flash memory or other non-volatile solid state memory. In some examples, the memory 620 may preferably include memories set remotely with respect to the processor 610, wherein these remote memories may be connected to the device for preview play via the network. The examples of the network include but are not limited to internet, intranet, local area network (LAN), mobile communication network and their combinations.

The input device 630 may receive the information of a number or a character as inputted, and generate key input signals relating to the user setting and function control of the device for preview play. The output device 640 may include a display device such as a display screen.

The one or more modules are stored in the memory 620. When the one or more modules are executed by one or more processors 610, the method for preview play according to any of the above examples are executed.

The above product may execute the method provided by the embodiments of the present disclosure, and has the corresponding functional module for executing the method, and therefore has beneficial effect. For the details that are not fully described in this embodiment, please refer to the methods provided by the embodiments of the present disclosure.

The electronic device of the embodiments of the present disclosure may be embodied in various forms, which include but are not limited to the following device.

(1) Mobile communication device, which is characterized by the mobile communication function, and the main objective of which is to provide voice communication and data communication. This kind of terminal includes: smart phone (e.g. iPhone), multimedia phone, feature phone and low-level phone etc.

(2) Ultra mobile personal computer device, which belongs to the range of personal computer, has the function of computing and processing and generally can also be used in mobile internet. This kind of terminal includes: PDA, MID and UMPC device etc., such as iPad.

(3) Portable entertainment device, which may display and play multimedia contents. This kind of device includes: audio and/or video player (e.g. iPod), hand-held game machine, electronic book device, smart toy and portable vehicle navigation device.

(4) Server, which is a device that provides computing service. The configuration of the server includes processor, hard disk, memory and system bus etc. The architecture of a server is similar to that of a general computer. However, the sever has a higher demanding with respect to the processing ability, stability, reliability, safety, expansibility and manageability etc, because the server is required to provide more reliable service.

(5) Other electronic device having function of data interaction.

The examples of the device have been described above for illustrative purposes only, wherein the units described as separated members may or may not be separated physically. The members shown as units may or may not be physical unit, that is, they may be located at one place, or may be distributed to a number of units in a network. The objective of the examples of the present disclosure may be achieved by selecting a part or all of the modules according to actual demand.

From the description of the above examples, the person skilled in the art may understand clearly that respective examples may be implemented by software in combination with a hardware platform, or by hardware only. Based on this understanding, the nature or the part contributory to the prior art of the technical solution as described above may be embodied in the form a computer software product, which may be stored in a computer-readable storage media, such as ROM/RAM, magnetic disk, optical disk etc., and may include a number of instructions for making a computer device (which may be a personal computer, a server or a network device etc.) execute the method according to the respective examples or a part of an example.

It should be noted that the examples as described above are only for the purpose of illustrating the solution of the present disclosure, without limiting the scope thereof. Although the present disclosure have been described according to the previous examples, the person skilled in the art will appreciate that various modifications to the solution recorded in the respective examples and equivalent substitutions for part of the features are possible, without departing from the scope and spirit of the present application as defined in the accompanying claims.

What is claimed is:

1. A method for preview play, which is applied to a terminal, wherein the method comprises:
determining a flag of a preview window when the preview window receives a play instruction;
obtaining a pre-built corresponding relation of the flag of the preview window and a video resource;
determining the video resource corresponding to the flag of the preview window according to the corresponding relation; and
playing the video resource in the preview window.

2. The method for preview play according to claim 1, wherein after playing the video resource in the preview window, the method further comprises:
closing a sound of playing the video resource in the preview window when a target preview window receives the play instruction;
determining the target video resource corresponding to the flag of the target preview window according to the corresponding relation; and
playing the target video resource in the target preview window.

3. The method for preview play according to claim 1, wherein after playing the video resource in the preview window, the method further comprises:
stopping playing the video resource in the preview window when a target preview window receives the play instruction;
determining the target video resource corresponding to the flag of the target preview window according to the corresponding relation; and
playing the target video resource in the target preview window.

4. The method for preview play according to claim 1, wherein after determining the video resource corresponding to the flag of the preview window according to the corresponding relation, the method further comprises:
judging whether there exists the video resource corresponding to the flag of the preview window;
triggering the step of playing the video resource in the preview window when there exists the video resource corresponding to the flag of the preview window; and
displaying a prompt message that there does not exist the video resource in the preview window when there does not exist the video resource corresponding to the flag of the preview window.

5. The method for preview play according to claim 1, wherein the step of playing the video resource in the preview window comprises:
determining a play start time corresponding to the video resource; and
starting playing the video resource from the play start time in the preview window.

6. A non-transitory computer-readable storage medium storing executable instructions that, when executed by an electronic device with a touch-sensitive display, cause the electronic device to:
determine a flag of a preview window when the preview window receives a play instruction;
obtain a pre-built corresponding relation of the flag of the preview window and a video resource;
determine the video resource corresponding to the flag of the preview window according to the corresponding relation; and
play the video resource in the preview window.

7. The non-transitory computer-readable storage medium according to claim 6, wherein after playing the video resource in the preview window, the executable instructions further cause the electronic device to:
close a sound of playing the video resource in the preview window when a target preview window receives the play instruction;
determine the target video resource corresponding to the flag of the target preview window according to the corresponding relation; and
play the target video resource in the target preview window.

8. The non-transitory computer-readable storage medium according to claim 6, wherein the executable instructions further cause the electronic device to:
stop playing the video resource in the preview window when a target preview window receives the play instruction;
determine the target video resource corresponding to the flag of the target preview window according to the corresponding relation; and
play the target video resource in the target preview window.

9. The non-transitory computer-readable storage medium according to claim 6, wherein the executable instructions further cause the electronic device to:
judge whether there exists the video resource corresponding to the flag of the preview window;
trigger the step of playing the video resource in the preview window when there exists the video resource corresponding to the flag of the preview window; and
display a prompt message that there does not exist the video resource in the preview window when there does not exist the video resource corresponding to the flag of the preview window.

10. The non-transitory computer-readable storage medium according to claim 6, wherein in the step of playing the video resource in the preview window, the executable instructions further cause the electronic device to
determine a play start time corresponding to the video resource; and
start playing the video resource from the play start time in the preview window.

11. An electronic device, comprising:
at least one processor; and
a memory;
a memory communicably connected with the at least one processor for storing instructions executable by the at least one processor, wherein execution of the instructions by the at least one processor causes the at least one processor to:
determine a flag of a preview window when the preview window receives a play instruction;
obtain a pre-built corresponding relation of the flag of the preview window and a video resource;
determine the video resource corresponding to the flag of the preview window according to the corresponding relation; and
play the video resource in the preview window.

12. The electronic device according to claim 11, wherein after playing the video resource in the preview window, the at least one processor is further caused to:
close a sound of playing the video resource in the preview window when a target preview window receives the play instruction;
determine the target video resource corresponding to the flag of the target preview window according to the corresponding relation; and
play the target video resource in the target preview window.

13. The electronic device according to claim 11, wherein the at least one processor is further caused to:
stop playing the video resource in the preview window when a target preview window receives the play instruction;
determine the target video resource corresponding to the flag of the target preview window according to the corresponding relation; and
play the target video resource in the target preview window.

14. The electronic device according to claim 11, wherein the at least one processor is further caused to:
judge whether there exists the video resource corresponding to the flag of the preview window;
trigger the step of playing the video resource in the preview window when there exists the video resource corresponding to the flag of the preview window; and
display a prompt message that there does not exist the video resource in the preview window when there does not exist the video resource corresponding to the flag of the preview window.

15. The electronic device according to claim 11, wherein in the step of playing the video resource in the preview window, the at least one processor is further caused to:
determine a play start time corresponding to the video resource; and
start playing the video resource from the play start time in the preview window.
